(19) United States
(12) Patent Application Publication
(10) Pub. No.: US 2018/0329581 A1
(43) Pub. Date: Nov. 15, 2018

(54) GENERATING A CATALOG FOR A WEB PAGE

(71) Applicant: International Business Machines Corporation, Armonk, NY (US)

(72) Inventors: Yang Liu, Shanghai (CN); Yi Fan YY Ruan, Shanghai (CN); Ying Shao, Shanghai (CN); Jing VL Sun, Shanghai (CN); Xiao Ming XM Zhang, Shanghai (CN)

(21) Appl. No.: 15/595,069

(22) Filed: May 15, 2017

(51) Int. Cl. G06F 3/0482; G06F 17/30; H04L 29/08

(52) U.S. Cl. CPC G06F 3/0482; H04L 67/02; G06F 17/30873; G06F 17/30882

(57) ABSTRACT

A catalog attribute and catalog program code containing the catalog attribute can be identified in a document object model (DOM) for a web page. The catalog program code can define a structure of a catalog for the web page. Responsive to identifying the catalog program code, the catalog for the web page can be generated by processing the catalog program code. The catalog can include a plurality of user selectable catalog items. At least a first portion of the catalog items can be configured to, in response to being selected by the user, navigate the user to a respective content of the web page. The catalog can be presented in a user interface.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates to data processing, and more specifically, to web pages.

A web page is an electronic document, written in a programming language (e.g., HTML or comparable markup language), configured for communication over a communication network (e.g., the Internet, an intranet, etc.) and for presentation by a web browser on a display. A web browser accesses a webpage via a network and coordinates various web resource elements for the web page, such as style sheets, scripts, and images, to render the web page on the display.

Responsive to receiving a web page, a web browser typically parses the HTML code from the web page and constructs a document object model (DOM), for example as the web browser loads the web page. The DOM is an application programming interface (API) that defines the logical structure of the web page and the way the web page is accessed and manipulated. In this regard, a DOM is an internal representation of a web page in the form of a hierarchical structure of nodes.

### SUMMARY

A method includes identifying, in a document object model (DOM) for a web page, a catalog attribute and catalog program code containing the catalog attribute, the catalog program code defining a structure of a catalog for the web page. The method also can include, responsive to identifying the catalog program code, generating, using a processor, the catalog for the web page by processing the catalog program code. The catalog can include a plurality of user selectable catalog items. Each of at least a first portion of the catalog items can be configured to, in response to being selected by the user, navigate the user to a respective content of the web page. The method also can include presenting the catalog in a user interface.

A system includes a processor programmed to initiate executable operations. The executable operations include identifying, in a document object model (DOM) for a web page, a catalog attribute and catalog program code containing the catalog attribute, the catalog program code defining a structure of a catalog for the web page. The executable operations also can include, responsive to identifying the catalog program code, generating the catalog for the web page by processing the catalog program code. The catalog can include a plurality of user selectable catalog items. Each of at least a first portion of the catalog items can be configured to, in response to being selected by the user, navigate the user to a respective content of the web page. The executable operations also can include presenting the catalog in a user interface.

A computer program includes a computer readable storage medium having program code stored thereon. The program code is executable by a processor to perform a method. The method includes identifying, by the processor, in a document object model (DOM) for a web page, a catalog attribute and catalog program code containing the catalog attribute, the catalog program code defining a structure of a catalog for the web page. The method also can include, responsive to identifying the catalog program code, generating, by the processor, the catalog for the web page by processing the catalog program code. The catalog can include a plurality of user selectable catalog items. Each of at least a first portion of the catalog items can be configured to, in response to being selected by the user, navigate the user to a respective content of the web page. The method also can include presenting, by the processor, the catalog in a user interface.

### BRIEF DESCRIPTION OF THE DRAWINGS

FIG. 1 is a block diagram illustrating an example of a computing environment.

FIG. 2 depicts an example of catalog program code of a web page.

FIG. 3 depicts an example of a user interface presenting a web page and a catalog for the web page.

FIG. 4 depicts another example of the user interface of FIG. 3.

FIG. 5 depicts another example of a user interface presenting a web page and a catalog for the web page.

FIG. 6 is a block diagram illustrating example architecture for a client device.

FIG. 7 is a flow chart illustrating an example of a method of presenting a catalog in a user interface.

### DETAILED DESCRIPTION

The present invention relates to data processing, and more specifically, to web pages. In accordance with the inventive arrangements disclosed herein, a catalog attribute and catalog program code containing the catalog attribute can be identified in source code of a web page, for example in a document object model (DOM) constructed from the source code. The catalog program code can define a structure of a catalog for the web page. Responsive to identifying the catalog program code, the catalog for the web page can be generated (e.g., constructed) by processing the catalog program code. The catalog can include a plurality of user selectable catalog items, and may also include sub lists of additional catalog items. The catalog can be configured to be presented to a user, on a display for example, and configured to be navigable using a screen reader. The catalog can provide an overview of the structure of the web page to facilitate quick and easy access to various portions (e.g., content) of the web page. By making content of the web page easily navigable, use of the catalog can eliminate the trouble of manually searching the web page for content. This can be particularly useful for users of screen readers.

Program code for the catalog can be added to source code for an existing web page without otherwise affecting the web page's design and functionality. For example, the catalog program code can include a catalog attribute recognizable by a screen reader or a web browser having screen reading functionality. In response to identifying the catalog attribute in the source code (e.g., in a DOM constructed from the source code) a screen reader, or a web browser having screen reading functionality, can automatically generate the catalog from that portion of the source code including the catalog attribute. Web browsers not having screen reading functionality need not be configured to recognize the catalog attribute. Thus, such web browsers can ignore the portion of source code defining the catalog, and can present the web page in a conventional manner without presenting the catalog.

Several definitions that apply throughout this document now will be presented.

As defined herein, the term “document object model,” referred to herein by the acronym “DOM,” means an application programming interface, constructed from a source file of a web page, that defines a logical structure of the web page. A DOM comprises a plurality of nodes, wherein each node is an object representing a portion of the web page. The objects can be manipulated programmatically and any presentation changes occurring as a result of the manipulation may be reflected in presentation of the web page.

As defined herein, the term “catalog” means a listing of a plurality of portions of a web page in a systematic order.

As defined herein, the term “screen reader” means an application that processes a document object model to modify presentation of a corresponding web page in order to aid visually impaired users.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “client device” means a processing system including at least one processor and memory that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

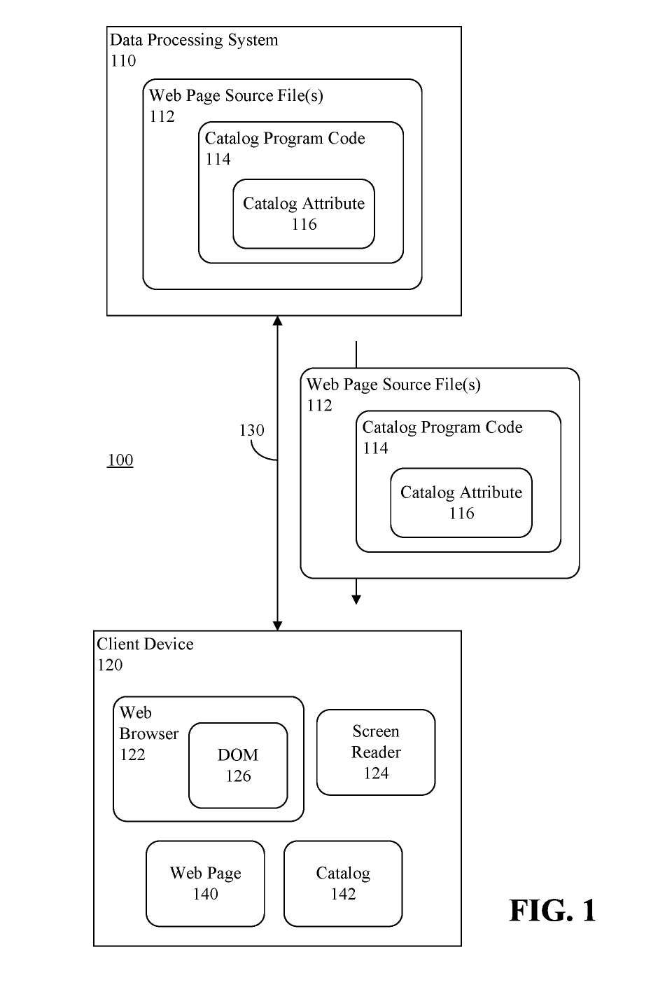

FIG. 1 is a block diagram illustrating an example of a computing environment 100. The computing environment 100 can include a data processing system 110 comprising at least one processor and memory. The data processing system 110 can be, for example, a web server. The data processing system 110 can host at least one web page. More particularly, the data processing system 110 can store one or more source files 112 for the web page, and provide the source files 112 to other systems (e.g., client devices) accessing the web page. At least one of the source files 112 can include catalog program code 114 that defines a structure of a catalog. The catalog program code 114 can include at least one catalog attribute 116. The catalog attribute 116 can indicate that the catalog program code 114 defines the catalog.

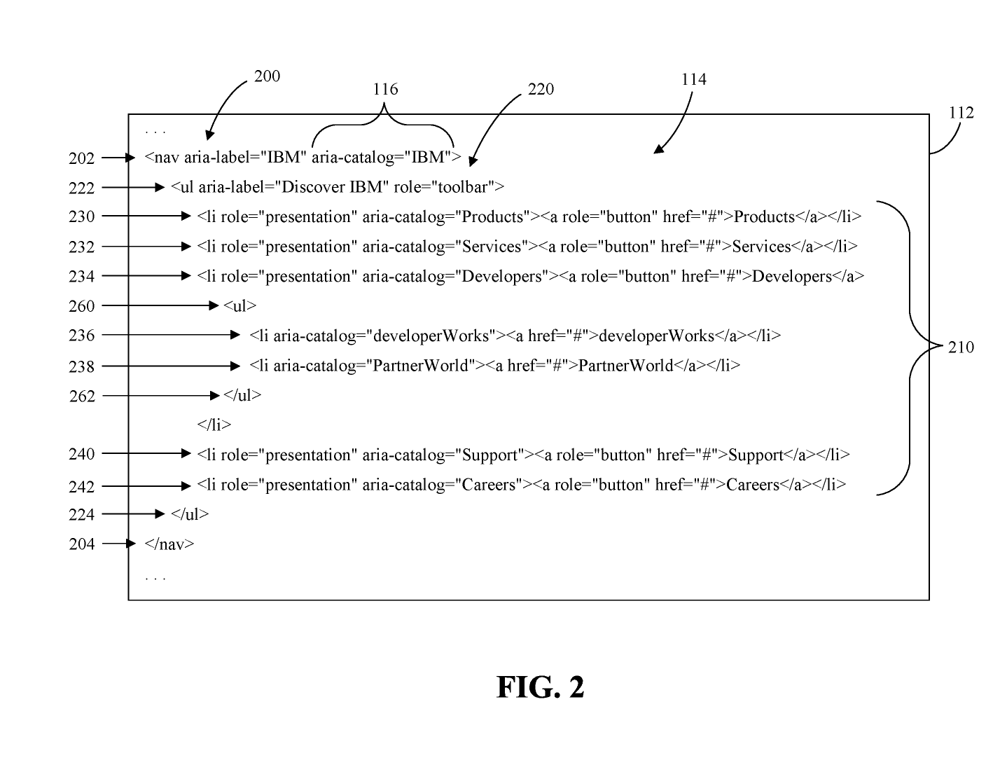

FIG. 2 depicts an example of the catalog program code 114 contained in the source file 112. In addition to the catalog program code 114, the source file 112 also can include other computer program code (not shown). The example presented in FIG. 2 is presented merely for purposes of understanding. It will be understood by those skilled in the art that the catalog program code 114 is not limited to this example.

The catalog program code 114 can include the catalog attribute 116. The catalog attribute 116 can indicate that the catalog program code 114 defines a structure of a catalog for the web page, as will be further described. In illustration, the catalog attribute 116 can be provided in a navigation element 200 of the catalog program code 114. The navigation element 200 can be a Hypertext Markup Language (HTML), or other markup language, element defining a set of navigation links 210. Each navigation link 210 can define a user selectable catalog item.

For example, using HTML, the catalog attribute 116 can be included in an opening nav tag 202 for the navigation element 200. The navigation links 210 can be provided between the opening nav tag 202 and a closing nav tag 204 of the navigation element 200. In one non-limiting arrangement, the navigation links 210 can be defined in an unstructured list, indicated by an opening ul tag 222 and a closing ul tag 224 of an unstructured list element 220. The navigation links 210 can be, for example, defined using list elements 230, 232, 234, 236, 238, 240, 242.

One or more of the navigation links can be provided in a sub list. For example, the list elements 236, 238 can be defined within the list element 234, for example between an opening ul tag 260 and a closing ul tag 262 defined within the list element 234. Thus, the catalog items defined by the list elements 236, 238 can be presented in the catalog in a sub list of the catalog item defined by the list element 234.

Referring again to FIG. 1, the computing environment 100 can include a client device 120. The client device 120 can include a web browser 122 and a screen reader 124. In one non-limiting arrangement, the screen reader 124 can be a component of the web browser 122. The client device 120 can be communicatively linked to the data processing system 110 via at least one communication network 130. The communication network 130 is the medium used to provide communications links between various devices and data processing systems connected together within the computing environment 100. The communication network 130 may include connections, such as wire, wireless communication links, or fiber optic cables. The communication network 130 can be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or similar technologies.

In operation, the client device (e.g., the web browser 122) can access, via the communication network 130, the source file(s) 112 for the web page from the data processing system 110. At least one of the source files 112 can include the catalog program code 114, including the catalog attribute 116. Responsive to the web browser 122 receiving a source file 112 from the data processing system 110, the web browser 122 can create a DOM 126 for the web page. For example, the web browser 122 can create the DOM 126 when loading the web page 140 using the source file 112.

The DOM 126 can include a plurality of nodes. Each node is an object representing a respective portion of the web page source file 112. In this regard, the DOM 126 can include an element node for each HTML element included in the catalog program code 114, as well as an element node for each other HTML element contained other portions of the source file 112. Moreover, the DOM 126 can include an attribute node for each HTML attribute in the catalog program code 114, including the catalog attribute 116, as well as an attribute node for each other HTML attribute contained other portions of the source file 112. Further, the DOM 126 can include text nodes for text inside HTML elements.

Responsive to the web browser loading a web page 140 from the source code contained in the source file 112, or responsive to a user input activating the screen reader 124 to perform screen reading functions, the screen reader 124 can access the DOM 126 from the web browser 122 and search the DOM 126 for the catalog attribute 116 (e.g., a node representing the catalog attribute 116). The screen reader 124 can be configured to recognize the catalog attribute 116 and automatically generate (e.g., construct), in real time in response to identifying the catalog attribute 116, a catalog 142 defined by the nodes representing navigation element 200 and other elements defined therein, including the user selectable catalog items defined by the navigation links 210. The catalog 142 can be presented in a manner distinct from the web page 140. For example, the web page 140 can be presented in a background on a display, and the catalog 142 can be presented in a foreground on the display. At least a portion of the catalog 142, as presented, can be translucent so that the web page 140 can be viewed behind the catalog 142, for example with shading overlaying the web page 140. In another arrangement, the catalog 142 can be presented above, below or beside the web page 140.

The catalog 142 can aid the user of the client device 120 in navigating the web page. For example, visually impaired users may find it difficult to browse the web page, for example due to a font size used for content presented by the web page and/or a sheer volume of content. The catalog 142, however, can be presented in a font size large enough for the user to view easily the catalog 142. Moreover, the catalog 142 can include sub lists of catalog items under certain catalog items, thus providing an intuitive and easy to understand way for the user to navigate the catalog 142 and the web page.

In illustration, the user may select, using a keyboard, keypad, buttons, and/or pointing device (e.g., mouse) a catalog item, for example a catalog item for “Services.” In response, the catalog 142 can navigate the web page to a portion of the web page pertaining to “Services” using a link defined in the list element 232 for that catalog item. If, on the other hand, the user selects a catalog item for “Developers,” defined by list element 234, the catalog 142 can expand that catalog item to display the sub items defined by the list elements 236, 238. In response to the user selecting one of the list elements 236, 238, the catalog 142 can navigate the web page to a portion of the web page pertaining to the selected catalog item using a link defined in the list element 236, 238 for that catalog item.

Further, the screen reader 124 can be configured to implement text-to-speech synthesis in order to read the catalog items to the user. For example, the screen reader 124 can read to the user text assigned to each catalog item. For example, if a catalog item is defined by the list element 230, the screen reader 124 can read the word “Products” assigned to that list element 230, and so on. The screen reader 124 also can be configured to detect spoken utterances of the user, process the spoken utterances using speech recognition, and initiate operations based on the spoken utterances.

For example, the user may utter “select services.” In response, the screen reader 124 can select the catalog item (e.g., a button) titled “Services” from the catalog 142. In response, the catalog 142 can navigate the web page to a portion of the web page pertaining to “Services” using a link defined in the list element 232 for that catalog item. If, however, the user utters “developers,” the screen reader 124 can select the catalog item (e.g., a button) titled “Developers” from the catalog 142, the catalog 142 can expand that catalog item to display the sub items defined by the list elements 236, 238. Further, the screen reader 124 can read the sub items to the user using text-to-speech synthesis. The user can provide a spoken utterance to select one of the menu items defined by the list elements 236, 238 and initiate the screen reader to select the corresponding menu item. In response, the catalog 142 can navigate the web page to a portion of the web page pertaining to the selected catalog item using a link defined in the list element 236, 238 for that catalog item. Screen readers 124 that implement text-to-speech synthesis and speech recognition are known in the art.

The screen reader 124 can be natively configured to recognize the catalog attribute 116 and generate the catalog 142, or such functionality can be added to the screen reader 124. For example, such functionality can be provided by a plugin added to the screen reader 124. The plugin can be computer program code added to the screen reader 124, for instance when, or after, the screen reader 124 is installed on the client device 120.

In one arrangement, the source file 112, and thus the DOM 126, can include computer program code (e.g., Javascript™ code) configured to execute in response to loading of the web page being initiated on the client device 120. The program code can be configured to search a registry of the client device 120 to determine whether a screen reader is installed on the client device and, if so, identify the particular screen reader. Responsive to identifying the particular screen reader, the program code can execute to present a notification via a user interface of the client device 120 (e.g., via a display or audio output transducer) to prompt the user to choose whether to allow installation of a plugin to the screen reader 124 to provide catalog functionality. Responsive to receiving from the user a response authorizing the plugin to be installed, the program code can select the appropriate plugin for the screen reader 124 and initiate installation of the plugin to the screen reader 124.

In another arrangement, one or more of the functions described herein as being performed by the screen reader 124 can be performed by the web browser 122. For example, the web browser 122 can be natively configured to recognize the catalog attribute 116 and automatically generate, in real time, the catalog 142, or such functionality can be added to the web browser 122. For instance, such functionality can be provided by a plugin added to the web browser 122. Again, the plugin can be computer program code added to the web browser 122, for instance when, or after, the web browser 122 is installed on the client device 120. In one arrangement, computer program code (e.g., Javascript™ code) configured to execute in response to loading of the web page being initiated on the client device 120 to provide catalog functionality to the web browser 122, for example in a manner similar to that described above for providing catalog functionality to the screen reader 124.

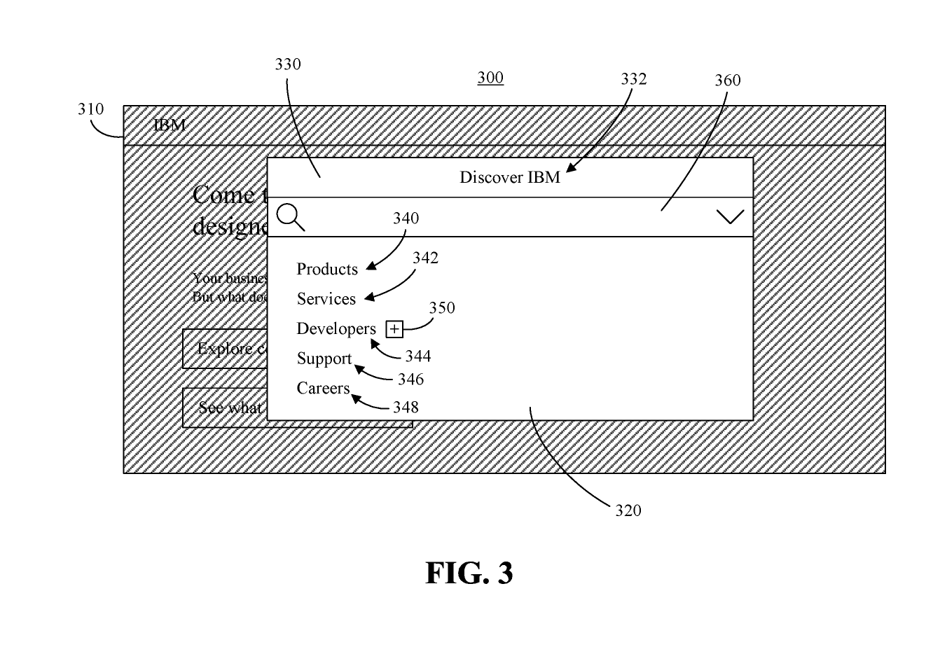

FIG. 3 depicts an example of a user interface 300 presenting a web page 310 and a catalog 320 for the web page 310. The user interface 300 can be presented by the client device 120, for example on a display within, or attached to, the client device 120. In one arrangement, the web page 310 can be presented by the web browser 122 and the catalog 320 can be presented by the screen reader 124. In this regard, both the web browser 122 and the screen reader 124 can interact with the user interface to present the web page 310 and catalog 320. Moreover, the screen reader 124 can interface with the web browser 122 to pass web page navigation commands to the web page 310, for example via the DOM 126. In another arrangement, the web browser 122 can present both the web page 310 and the catalog 320.

In this example, the catalog 320 include a toolbar 330 defined by the navigation element 200 of FIG. 2 and presenting text 332 contained in the opening ul tag 222. Further, the catalog 320 can include catalog items 340, 342, 344, 346, 348 defined by the respective list elements 230, 232, 234, 240, 242 of FIG. 2. At least a portion of the catalog items 340-348, for example the catalog items 340, 342, 346, 348 can be configured to, in response to being selected by the user, navigate the user to respective content of the web page 310. For example, the respective list elements 230, 232, 240, 242 that define the catalog items 340, 342, 346, 348 can include links to the respective content.

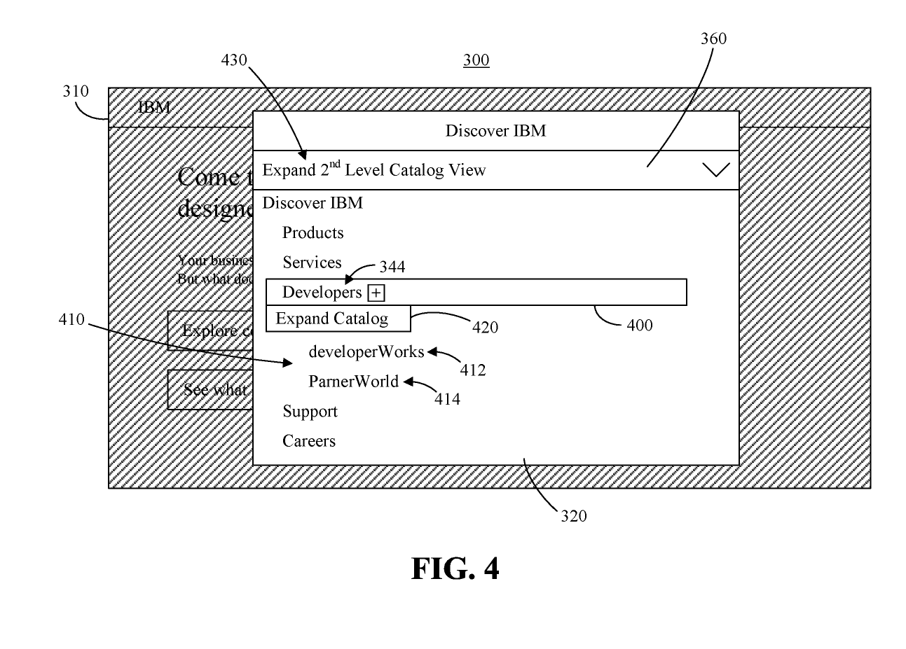

As noted, list elements 236, 238 can be defined in a sub list within the list element 234. Accordingly, the catalog 320 can present a user selectable user interface item 350 that, when selected, causes the catalog 320 to present catalog items defined by the list elements 236, 238, for example in a sub list of catalog items presented below the catalog item 344 (shown in FIG. 4). The user interface item 350 can be presented proximate to the catalog item 344, for example immediately next to the catalog item (e.g., immediately before or after the catalog item 344).

Optionally, the catalog 320 can include a search/navigation bar 360 (not shown in the example catalog program code 114 of FIG. 2). The search/navigation bar 360 can be configured to receive user inputs to search the web page 310, search the catalog 320, expand the catalog 320 to present one or more levels of sub lists of catalog items, and so on.

FIG. 4 depicts another example of the user interface 300 of FIG. 3. In this example, assume that the user has selected the catalog item 344. Responsive to the user selection of the catalog item 344, the screen reader 124 (or web browser 122) can indicate the user selection, for example by highlighting the catalog item 344 or presenting some other visual effect 400 indicating that the catalog item 344 has been selected. The catalog item 344 item can be configured to, in response to be selected by the user, initiate presentation of catalog items 412, 414 contained in a sub list 410. The catalog items 412, 414 can be defined by the list elements 236, 238 of FIG. 2. The catalog 320 can indicate a hierarchical relationship between the catalog items 412, 414 contained in the sub list 410 and the catalog item 344 that initiates presentation of the catalog items 412, 414. For example, the catalog items 412, 414 can be presented below the catalog item 344 with a left justification offset from a left justification of the catalog item 344. Still, the hierarchical relationship can be indicated in any other suitable manner and the present arrangements are not limited in this regard.

In illustration, responsive to the user selection of the catalog item 344, the screen reader 124 (or web browser 122) can process the list element 234 defining the catalog item 344 to determine whether the list element 234 includes a sub list. In response to determining that the list element 234 does include a sub list, the screen reader 124 (or web browser 122) can expand the catalog 320 to present the sub list 410. In another arrangement, in response to determining that the list element 234 does include a sub list, the screen reader 124 (or web browser 122) can present a user interface element 420 that provides the user a selectable option to expand the catalog item 344 to display the sub list 410. Responsive to the user selecting the user interface element 420, the screen reader 124 (or web browser 122) can expand the catalog 320 to present the sub list 410.

In another arrangement, the search/navigation bar 360 can be configured to, responsive to a user selection, expand the catalog 320 to display sub lists. For example, the search/navigation bar 360 can be configured to, responsive to be selected by the user, present a list of search/navigation items. The search/navigation items can include a search/navigation item 430 that, responsive to being selected by the user, causes the catalog 320 to expand to a second level catalog view in which a first level of sub lists are presented. Additional search/navigation items can be presented to enable the user to initiate the catalog 320 to expand to various other levels of catalog views, including various other levels of sub lists, and the present arrangements are not limited in this regard.

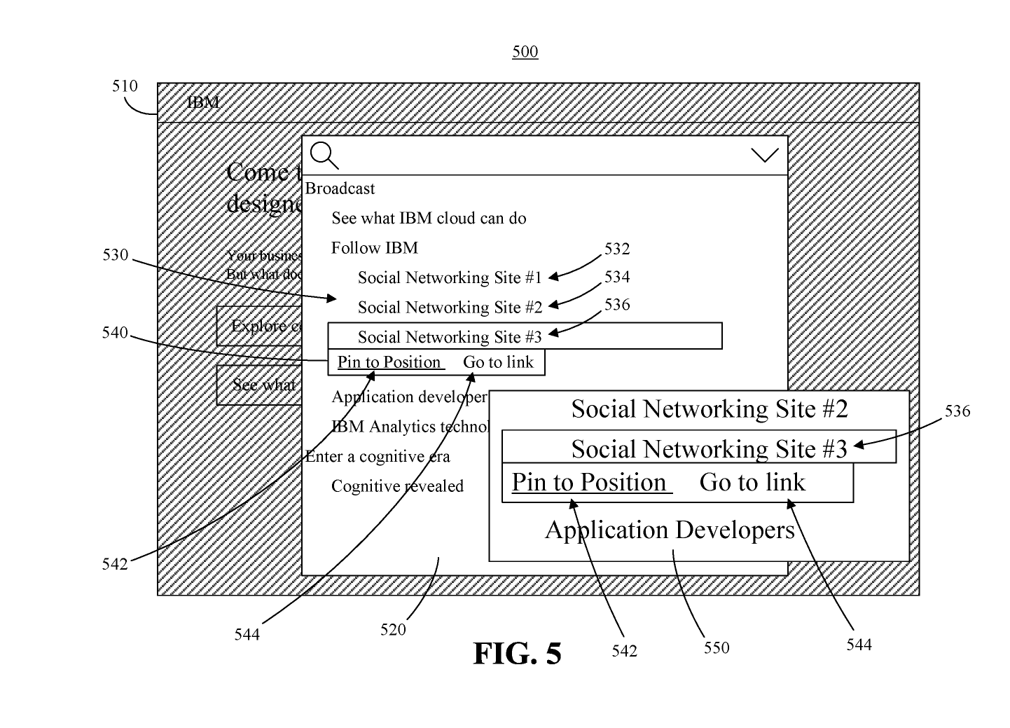

FIG. 5 depicts another example of a user interface 500 presenting a web page 510 and a catalog 520 for the web page 510. A source file (not shown) for the web page 510 can include catalog program code (not shown) including a navigation element and list elements. One or more of the list elements may include sub lists. The user interface 500 can be presented by the client device 120, for example on a display within, or attached to, the client device 120.

In this example, the catalog 520 can include a sub list 530, including a catalog items 532, 534, 536. Responsive to the user selecting the catalog item 536, the screen reader 124 (or web browser 122) can process the list element defining the catalog item 536 to determine whether the list element includes a link (e.g., a link to a respective external web page). The link can be, for example, a hyperlink. Responsive to determining that the list element does include such a link, the screen reader 124 (or web browser 122) can present a user interface element 540 that provides the user one or more selectable user interface items related to the link. An example of such a user interface item is a user interface item 542 that, when selected, pins the catalog item 536 to a position. Responsive to the user selecting the user interface item 542, the catalog 520 can continue presenting the catalog item 532, even if the catalog 520 is collapsed in order to stop showing other catalog items 534, 536 included in the sub list 530. Another example of such a selectable user interface item 542 is a user interface item 544 that, when selected, initiates the web browser 122 (or screen reader 124) to navigate to the web page identified by the link. Responsive to the user selecting the user interface item 542, the web browser 122 (or screen reader 124) can navigate to the other web page. The web page can be loaded in a new browser tab or in a tab presently displaying the web page 510. In one arrangement, the screen reader 124 can apply a visual effect to the user interface item 542, 544 selected, or navigated to, by the user. For example, responsive to the user navigating to the user interface item 542, the user interface item 542 can be underlined, highlighted, etc.

In a further arrangement, the screen reader 124 can present a view 550 (e.g., window) presenting of a portion of the catalog 520, for example, a portion of the catalog 520 presenting the catalog item 536 and the user interface element 540, in an enlarged format. The enlarged format can facilitate reading of that portion of the catalog 520 by the user, for example, if the user is visually impaired. The screen reader 124 can continuously and dynamically, in real time, re-render the view 550 to follow a cursor (not shown) moved by the user using a pointing device, keyboard or keypad, or to follow user selections of catalog items. Moreover, the user can interact with the view 550 to select the catalog items (e.g., catalog item 536) and user interface items (e.g., user interface items 542, 544). Thus, the view 550 can facilitate user interactions with the catalog 520.

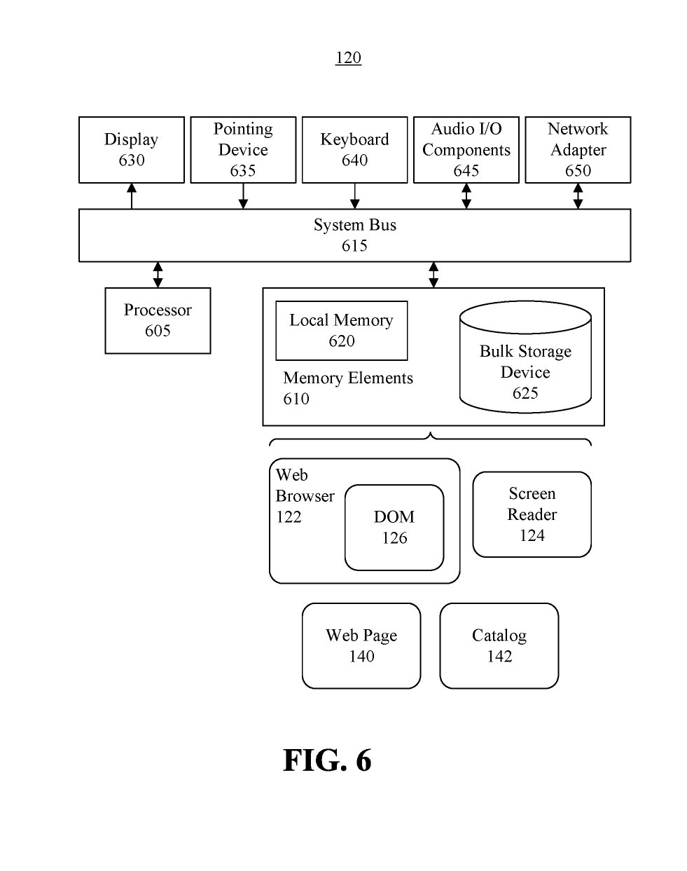

FIG. 6 is a block diagram illustrating example architecture for the client device 120. The client device 120 can include at least one processor 605 (e.g., a central processing unit) coupled to memory elements 610 through a system bus 615 or other suitable circuitry. As such, the client device 120 can store program code within the memory elements 610. The processor 605 can execute the program code accessed from the memory elements 610 via the system bus 615. It should be appreciated that the client device 120 can be implemented in the form of any system including a processor and memory that is capable of performing the functions and/or operations described within this specification.

The memory elements 610 can include one or more physical memory devices such as, for example, local memory 620 and one or more bulk storage devices 625. Local memory 620 refers to random access memory (RAM) or other non-persistent memory device(s) generally used during actual execution of the program code. The bulk storage device(s) 625 can be implemented as a hard disk drive (HDD), solid state drive (SSD), or other persistent data storage device. The client device 120 also can include one or more cache memories (not shown) that provide temporary storage of at least some program code in order to reduce the number of times program code must be retrieved from the bulk storage device 625 during execution.

Input/output (I/O) devices such as a display 630, a pointing device 635, a keyboard 640 and audio I/O components 645 can be coupled to the client device 120. The I/O devices can be coupled to the client device 120 either directly or through intervening I/O controllers. For example, the display 630 can be coupled to the client device 120 via a graphics processing unit (GPU), which may be a component of the processor 605 or a discrete device. The audio I/O components 645 can include an input audio transducer, an output audio transducer, an analog to digital (A/D) converter, a digital to analog (D/A) converter, etc. One or more network adapters 650 also can be coupled to client device 120 to enable the client device 120 to become coupled to other systems, computer systems, remote printers, and/or remote storage devices through intervening private or public networks. Modems, cable modems, transceivers, and Ethernet cards are examples of different types of network adapters 650 that can be used with the client device 120.

As pictured in FIG. 6, the memory elements 610 can store the components of the client device 120, namely the web browser 122, the screen reader 124, the DOM 126, and the catalog 142. Further, the client device 120 can render the web page 140 on the display 630 based on the DOM 126. Being implemented in the form of executable program code, the web browser 122 and screen reader 124 can be executed by the client device 120 and, as such, can be considered part of the client device 120. Moreover, the web browser 122, screen reader 124, DOM 126, web page 140 and catalog 142 are functional data structures that impart functionality when employed as part of the client device 120.

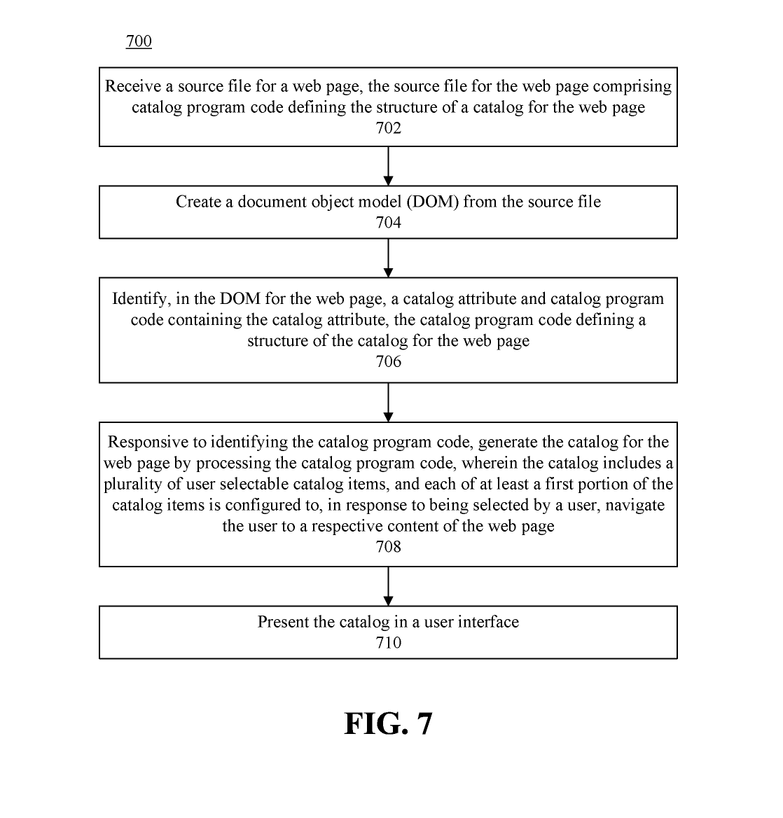

FIG. 7 is a flow chart illustrating an example of a method 700 of presenting a catalog in a user interface. The method 700 can be implemented by the client device 120 of FIGS. 1 and 6. At step 702, the client device 120 can receive a source file for a web page, the source file for the web page comprising catalog program code defining the structure of a catalog for the web page. At step 704, the client device 120 can create a document object model (DOM) from the source file. At step 706, the client device 120 can identify, in the DOM for the web page, a catalog attribute and catalog program code containing the catalog attribute, the catalog program code defining a structure of the catalog for the web page. At step 708, the client device 120 can, responsive to identifying the catalog program code, generate (e.g., construct) the catalog for the web page by processing the catalog program code. The catalog includes a plurality of user selectable catalog items. Each of at least a first portion of the catalog items is configured to, in response to being selected by a user, navigate the user to a respective content of the web page. At step 710, the client device 120 can present the catalog in a user interface, for example on a display of the client device 120.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
identifying, in a document object model (DOM) for a web page, a catalog attribute and catalog program code containing the catalog attribute, the catalog program code defining a structure of a catalog for the web page;
responsive to identifying the catalog program code, generating, using a processor, the catalog for the web page by processing the catalog program code, wherein:
the catalog comprises a plurality of user selectable catalog items; and
each of at least a first portion of the catalog items is configured to, in response to being selected by a user, navigate the user to a respective content of the web page; and
presenting the catalog in a user interface.

2. The method of claim 1, further comprising:
receiving a source file for the web page, the source file for the web page comprising the catalog program code defining the structure of the catalog for the web page; and
creating the DOM from the source file.

3. The method of claim 1, wherein the catalog is presented with a presentation of the web page, wherein the web page is presented in a background and the catalog is presented in a foreground.

4. The method of claim 1, wherein each of at least a second portion of the catalog items is configured to, in response to being selected by the user, initiate presentation of at least one additional catalog item in a sub list.

5. The method of claim 4, wherein the catalog indicates a hierarchical relationship between the at least one additional catalog item in the sub list and a respective catalog item that initiates presentation of the at least one additional catalog item.

6. The method of claim 1, wherein each at least a second portion of the catalog items comprises a link to a respective external web page.

7. The method of claim 1, wherein the catalog is configured to be presented by a screen reader.

8. A system, comprising:
a processor programmed to initiate executable operations comprising:
identifying, in a document object model (DOM) for a web page, a catalog attribute and catalog program code containing the catalog attribute, the catalog program code defining a structure of a catalog for the web page;
responsive to identifying the catalog program code, generating, using a processor, the catalog for the web page by processing the catalog program code, wherein:
the catalog comprises a plurality of user selectable catalog items; and
each of at least a first portion of the catalog items is configured to, in response to being selected by a user, navigate the user to a respective content of the web page; and
presenting the catalog in a user interface.

9. The system of claim 8, the executable operations further comprising:
receiving a source file for the web page, the source file for the web page comprising the catalog program code defining the structure of the catalog for the web page; and
creating the DOM from the source file.

10. The system of claim 8, wherein the catalog is presented with a presentation of the web page, wherein the web page is presented in a background and the catalog is presented in a foreground.

11. The system of claim 8, wherein each of at least a second portion of the catalog items is configured to, in response to being selected by the user, initiate presentation of at least one additional catalog item in a sub list.

12. The system of claim 11, wherein the catalog indicates a hierarchical relationship between the at least one additional catalog item in the sub list and a respective catalog item that initiates presentation of the at least one additional catalog item.

13. The system of claim 8, wherein each at least a second portion of the catalog items comprises a link to a respective external web page.

14. The system of claim 8, wherein the catalog is configured to be presented by a screen reader.

15. A computer program product comprising a computer readable storage medium having program code stored thereon, the program code executable by a processor to perform a method comprising:
identifying, in a document object model (DOM) for a web page, a catalog attribute and catalog program code containing the catalog attribute, the catalog program code defining a structure of a catalog for the web page;
responsive to identifying the catalog program code, generating, using a processor, the catalog for the web page by processing the catalog program code, wherein:
the catalog comprises a plurality of user selectable catalog items; and
each of at least a first portion of the catalog items is configured to, in response to being selected by a user, navigate the user to a respective content of the web page; and
presenting the catalog in a user interface.

16. The computer program product of claim 15, the method further comprising:
receiving a source file for the web page, the source file for the web page comprising the catalog program code defining the structure of the catalog for the web page; and
creating the DOM from the source file.

17. The computer program product of claim 15, wherein the catalog is presented with a presentation of the web page, wherein the web page is presented in a background and the catalog is presented in a foreground.

18. The computer program product of claim 15, wherein each of at least a second portion of the catalog items is configured to, in response to being selected by the user, initiate presentation of at least one additional catalog item in a sub list.

19. The computer program product of claim 18, wherein the catalog indicates a hierarchical relationship between the at least one additional catalog item in the sub list and a respective catalog item that initiates presentation of the at least one additional catalog item.

20. The computer program product of claim 15, wherein each at least a second portion of the catalog items comprises a link to a respective external web page.
